(19) United States
(12) Patent Application Publication
(10) Pub. No.: US 2025/0254675 A1
(43) Pub. Date: Aug. 7, 2025

(54) METHODS AND APPARATUSES FOR SIDELINK BEAM MANAGEMENT

(71) Applicant: Lenovo (Beijing) Limited, Beijing (CN)

(72) Inventors: Xin Guo, Beijing (CN); Haipeng Lei, Beijing (CN); Zhennian Sun, Beijing (CN); Xiaodong Yu, Beijing (CN)

(73) Assignee: Lenovo (Beijing) Limited, Beijing (CN)

(21) Appl. No.: 18/855,964

(22) PCT Filed: Apr. 11, 2022
(86) PCT No.: PCT/CN2022/086182

§ 371 Date: Oct. 10, 2024

(51) Int. Cl. H04W 72/044; H04W 72/40

(52) U.S. Cl. CPC H04W 72/046; H04W 72/40

(57) ABSTRACT

Embodiments of the present disclosure relate to methods and apparatuses for sidelink (SL) beam management. According to an embodiment of the present disclosure, a user equipment (UE) can include: a processor configured to: obtain configuration information for beam pairing based on configuration or pre-configuration, wherein the configuration information includes at least one of: a configuration for sidelink beam pairing block (S-BPB); a configuration for sidelink beam pairing reference signal (sl-BP-RS); a configuration for sidelink beam pairing feedback (sl-BP-FB); or association pattern (s) between occasions for sl-BP-RS and sl-BP-FB; and determine resource (s) for transmitting sl-BP-RS (s) based on the obtained configuration information in response to the UE becoming a UE for transmitting sl-BP-RS (s); a transmitter coupled to the processor and configured to: transmit the sl-BP-RS (s) on the determined resource (s); and a receiver coupled to the processor and configured to: receive sl-BP-FB (s) based on the obtained configuration information and the sl-BP-RS (s); wherein the processor is further configured to identify beam (s) of the UE based on the sl-BP-FB (s).

### TECHNICAL FIELD

Embodiments of the present application are related to wireless communication technology, and more particularly, related to methods and apparatuses for sidelink (SL) beam management.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability and to reduce latency and power consumption. With the development of 3GPP 5G networks, various aspects need to be studied and developed to perfect the 5G technology. Currently, details regarding beam management on SL need to be further discussed.

### SUMMARY OF THE APPLICATION

Embodiments of the present application at least provide a technical solution for SL beam management.

According to some embodiments of the present application, a user equipment (UE) may include: a processor configured to: obtain configuration information for beam pairing based on configuration or pre-configuration, wherein the configuration information includes at least one of: a configuration for sidelink beam pairing block (S-BPB); a configuration for sidelink beam pairing reference signal (sl-BP-RS); a configuration for sidelink beam pairing feedback (sl-BP-FB); or association pattern(s) between occasions for sl-BP-RS and sl-BP-FB; and determine resource(s) for transmitting sl-BP-RS(s) based on the obtained configuration information in response to the UE becoming a UE for transmitting sl-BP-RS(s); a transmitter coupled to the processor and configured to: transmit the sl-BP-RS(s) on the determined resource(s); and a receiver coupled to the processor and configured to: receive sl-BP-FB(s) based on the obtained configuration information and the sl-BP-RS(s); wherein the processor is further configured to identify beam(s) of the UE based on the sl-BP-FB(s).

In some embodiments of the present application, the UE becomes a UE for transmitting sl-BP-RS(s) in response to at least one of the following conditions: the UE is configured by a base station to be the UE for transmitting sl-BP-RS(s); or the UE determines to become the UE for transmitting sl-BP-RS(s).

In some embodiments of the present application, the configuration for S-BPB indicates at least one of: a duration of a sidelink beam pairing period for S-BPB; a sidelink beam pairing offset for S-BPB; a sidelink beam pairing interval for S-BPB; or a number of S-BPBs per sidelink beam pairing period.

In some embodiments of the present application, in order to determine resource(s) for transmitting the sl-BP-RS(s), the processor is configured to determine one or more occasions for S-BPB based on the configuration for S-BPB and an association pattern between occasions for sl-BP-RS and sl-BP-FB included in the configuration information.

In some embodiments of the present application, the configuration for sl-BP-RS includes a first set of primary sequences and a second set of secondary sequences for sl-BP-RS and indicates that an sl-BP-RS includes at least one of the following: type information indicating sl-BP-RS or sl-BP-FB; an identification (ID) of a UE transmitting the sl-BP-RS; a number of beams for transmitting the sl-BP-RS; a repetition number of each beam for transmitting the sl-BP-RS; an association pattern within the association pattern(s) between occasions for sl-BP-RS and sl-BP-FB in the configuration information; information indicating whether a beam correspondence is enabled on the UE transmitting the sl-BP-RS; or a priority of an intended traffic.

In some embodiments of the present application, in order to determine resource(s) for transmitting sl-BP-RS(s), the processor is configured to determine a primary sequence from the first set of primary sequences and a secondary sequence from the second set of secondary sequences for transmitting the sl-BP-RS(s).

In some embodiments of the present application, the configuration for sl-BP-FB includes an association between sequences for sl-BP-RS and sl-BP-FB and indicates that an sl-BP-FB includes at least one of: type information indicating sl-BP-RS or sl-BP-FB; an ID of a UE transmitting the sl-BP-FB; an sl-BP-RS occasion indicator; information indicating whether a beam associated with an occasion for sl-BP-RS indicated by the sl-BP-RS occasion indicator is a primary beam or a secondary beam; information indicating a reference signal received power (RSRP) measured on the beam associated with the occasion for sl-BP-RS indicated by the sl-BP-RS occasion indicator; or information indicating whether a beam correspondence is enabled on the UE transmitting the sl-BP-FB.

In some embodiments of the present application, the configuration for sl-BP-FB indicates at least one of the following: a duration of a sidelink beam pairing feedback period in a resource pool for sidelink transmission; an offset of a starting point of a sidelink beam pairing feedback period relative to a reference point, wherein the reference point is one of: (1) a first slot of the resource pool; (2) a starting point of a sidelink beam pairing period; or (3) an end point of a sidelink beam pairing period; or a frequency position for sl-BP-FB in the resource pool.

In some embodiments of the present application, each association pattern between occasions for sl-BP-RS and sl-BP-FB includes at least one of: an association pattern index; a repetition flag indicating a repetition order of sl-BP-RSs on beams; an order flag indicating an order of transmissions of sl-BP-RS(s) and sl-BP-FB(s); a maximum number of sl-BP-RS occasion indicators to be reported by a UE for transmitting sl-BP-FB(s); or a stop flag indicating a stop condition of transmissions of sl-BP-RS(s) and sl-BP-FB(s).

In some embodiments of the present application, an sl-BP-RS of the sl-BP-RS(s) is carried by an S-BPB and includes at least one of: a primary sequence; a secondary sequence; type information indicating sl-BP-RS; an ID of the UE; a number of beams for transmitting the sl-BP-RS; a repetition number of each beam for transmitting the sl-BP-RS; an association pattern of the association pattern(s) between occasions for sl-BP-RS and sl-BP-FB in the configuration information; information indicating whether a beam correspondence is enabled on the UE; or a priority of an intended traffic.

In some embodiments of the present application, an sl-BP-FB of the sl-BP-FB(s) is carried by an S-BPB and includes at least one of: a primary sequence; a secondary sequence; type information indicating sl-BP-FB; an ID of a UE transmitting the sl-BP-FB; an sl-BP-RS occasion indicator; information indicating whether a beam associated with an occasion for sl-BP-RS indicated by the sl-BP-RS occasion indicator is a primary beam or a secondary beam; information indicating an RSRP measured on the beam associated with the occasion for sl-BP-RS indicated by the sl-BP-RS occasion indicator; or information indicating whether a beam correspondence is enabled on the UE transmitting the sl-BP-FB.

In some embodiments of the present application, an sl-BP-FB of the sl-BP-FB(s) is carried by a sidelink transmission and includes at least one of: type information indicating sl-BP-FB; an ID of a UE transmitting the sl-BP-FB; an ID of the UE transmitting the sl-BP-RS(s); an sl-BP-RS occasion indicator; information indicating whether a beam associated with an occasion for sl-BP-RS indicated by the sl-BP-RS occasion indicator is a primary beam or a secondary beam; information indicating an RSRP measured on the beam associated with the occasion for sl-BP-RS indicated by the sl-BP-RS occasion indicator; or information indicating whether a beam correspondence is enabled on the UE transmitting the sl-BP-FB.

In some embodiments of the present application, the processor is further configured to scramble each sl-BP-RS by a radio network temporary identifier (RNTI) dedicated for sidelink beam pairing.

According to some other embodiments of the present application, a UE may include: a processor configured to: obtain configuration information for beam pairing based on configuration or pre-configuration, wherein the configuration information includes at least one of: a configuration for S-BPB; a configuration for sl-BP-RS; a configuration for sl-BP-FB; or association pattern(s) between occasions for sl-BP-RS and sl-BP-FB; a receiver coupled to the processor and configured to: receive sl-BP-RS(s) based on the obtained configuration information in response to the UE becoming a UE for transmitting sl-BP-FB(s); and a transmitter coupled to the processor; wherein the processor is further configured to: determine one or more sl-BP-RSs within the received sl-BP-RS(s) and beam(s) receiving the one or more sl-BP-RSs; and determine resource(s) for transmitting the sl-BP-FB(s) based on the obtained configuration information and the one or more sl-BP-RSs; and the transmitter is configured to transmit the sl-BP-FB(s) on the determined resource(s).

In some embodiments of the present application, the UE becomes a UE for transmitting sl-BP-FB(s) in response to at least one of the following conditions: the UE is configured by a base station to be the UE for transmitting sl-BP-FB(s); or the UE determines to become the UE for transmitting sl-BP-FB(s).

In some embodiments of the present application, the configuration for S-BPB indicates at least one of: a duration of a sidelink beam pairing period for S-BPB; a sidelink beam pairing offset for S-BPB; or a sidelink beam pairing interval for S-BPB; or a number of S-BPBs per sidelink beam pairing period.

In some embodiments of the present application, in order to determine resource(s) for transmitting the sl-BP-FB(s), the processor is configured to determine one or more occasions for S-BPB based on the configuration for S-BPB and the one or more sl-BP-RSs.

In some embodiments of the present application, the configuration for sl-BP-RS includes a first set of primary sequences and a second set of secondary sequences for sl-BP-RS and indicates that an sl-BP-RS includes at least one of the following: type information indicating sl-BP-RS or sl-BP-FB; an ID of a UE transmitting the sl-BP-RS; a number of beams for transmitting the sl-BP-RS; a repetition number of each beam for transmitting the sl-BP-RS; an association pattern within the association pattern(s) between occasions for sl-BP-RS and sl-BP-FB in the configuration information; information indicating whether a beam correspondence is enabled on the UE transmitting the sl-BP-RS; or a priority of an intended traffic.

In some embodiments of the present application, the configuration for sl-BP-FB includes an association between sequences for sl-BP-RS and sl-BP-FB and indicates that an sl-BP-FB includes at least one of: type information indicating sl-BP-RS or sl-BP-FB; an ID of a UE transmitting the sl-BP-FB; an sl-BP-RS occasion indicator; information indicating whether a beam associated with an occasion for sl-BP-RS indicated by the sl-BP-RS occasion indicator is a primary beam or a secondary beam; information indicating an RSRP measured on the beam associated with the occasion for sl-BP-RS indicated by the sl-BP-RS occasion indicator; or information indicating whether a beam correspondence is enabled on the UE transmitting the sl-BP-FB.

In some embodiments of the present application, in order to determine resource(s) for transmitting the sl-BP-FB(s), the processor is configured to determine a primary sequence and a secondary sequence based on the one or more sl-BP-RSs and the association between sequences for sl-BP-RS and sl-BP-FB.

In some embodiments of the present application, the configuration for sl-BP-FB indicates at least one of the following: a duration of a sidelink beam pairing feedback period in a resource pool for sidelink transmission; an offset of a starting point of a sidelink beam pairing feedback period relative to a reference point, wherein the reference point is one of: (1) a first slot of the resource pool; (2) a starting point of a sidelink beam pairing period; or (3) an end point of a sidelink beam pairing period; or a frequency position for sl-BP-FB in the resource pool.

In some embodiments of the present application, in order to determine resource(s) for transmitting the sl-BP-FB(s), the processor is configured to determine one or more occasions in the sidelink beam pairing feedback period based on the configuration for sl-BP-FB and the one or more sl-BP-RSs.

In some embodiments of the present application, each association pattern between occasions for sl-BP-RS and sl-BP-FB includes at least one of: an association pattern index; a repetition flag indicating a repetition order of sl-BP-RSs on beams; an order flag indicating an order of transmissions of sl-BP-RS(s) and sl-BP-FB(s); a maximum number of sl-BP-RS occasion indicators to be reported by a UE for transmitting sl-BP-FB(s); or a stop flag indicating a stop condition of transmissions of sl-BP-RS(s) and sl-BP-FB(s).

In some embodiments of the present application, an sl-BP-RS of the sl-BP-RS(s) is carried by an S-BPB and includes at least one of: a primary sequence; a secondary sequence; type information indicating sl-BP-RS; an ID of a UE transmitting the sl-BP-RS; a number of beams for transmitting the sl-BP-RS; a repetition number of each beam for transmitting the sl-BP-RS; an association pattern of the association pattern(s) between occasions for sl-BP-RS and sl-BP-FB in the configuration information; information indicating whether a beam correspondence is enabled on the UE transmitting the sl-BP-RS; or a priority of an intended traffic.

In some embodiments of the present application, an sl-BP-FB of the sl-BP-FB(s) is carried by an S-BPB and includes at least one of: a primary sequence; a secondary sequence; type information indicating sl-BP-FB; an ID of the UE; an sl-BP-RS occasion indicator; information indicating whether a beam associated with an occasion for sl-BP-RS indicated by the sl-BP-RS occasion indicator is a primary beam or a secondary beam; information indicating an RSRP measured on the beam associated with the occasion for sl-BP-RS indicated by the sl-BP-RS occasion indicator; or information indicating whether a beam correspondence is enabled on the UE.

In some embodiments of the present application, an sl-BP-FB of the sl-BP-FB(s) is carried by a sidelink transmission and includes at least one of: type information indicating sl-BP-FB; an ID of the UE; an ID of a UE transmitting the sl-BP-RS(s); an sl-BP-RS occasion indicator; information indicating whether a beam associated with an occasion for sl-BP-RS indicated by the sl-BP-RS occasion indicator is a primary beam or a secondary beam; information indicating an RSRP measured on the beam associated with the occasion for sl-BP-RS indicated by the sl-BP-RS occasion indicator; or information indicating whether a beam correspondence is enabled on the UE transmitting the sl-BP-FB.

In some embodiments of the present application, the processor is further configured to scramble each sl-BP-FB by an RNTI dedicated for sidelink beam pairing.

According to some other embodiments of the present application, a BS may include: a transmitter configured to: transmit configuration information for beam pairing, wherein the configuration information includes at least one of: a configuration for S-BPB; a configuration for sl-BP-RS; a configuration for sl-BP-FB; or association pattern(s) between occasions for sl-BP-RS and sl-BP-FB; a processor coupled to the transmitter; and a receiver coupled to the processor.

According to some other embodiments of the present application, a method performed by a UE may include: obtaining configuration information for beam pairing based on configuration or pre-configuration, wherein the configuration information includes at least one of: a configuration for S-BPB; a configuration for sl-BP-RS; a configuration for sl-BP-FB; or association pattern(s) between occasions for sl-BP-RS and sl-BP-FB; determining resource(s) for transmitting sl-BP-RS(s) based on the obtained configuration information in response to the UE becoming a UE for transmitting sl-BP-RS(s); transmitting the sl-BP-RS(s) on the determined resource(s); receiving sl-BP-FB(s) based on the obtained configuration information and the sl-BP-RS(s); and identifying beam(s) of the UE based on the sl-BP-FB(s).

In some embodiments of the present application, determining resource(s) for transmitting sl-BP-RS(s) includes determining one or more occasions for S-BPB based on the configuration for S-BPB and an association pattern between occasions for sl-BP-RS and sl-BP-FB included in the configuration information.

In some embodiments of the present application, the configuration for sl-BP-RS includes a first set of primary sequences and a second set of secondary sequences for sl-BP-RS, and determining resource(s) for transmitting sl-BP-RS(s) includes determining a primary sequence from the first set of primary sequences and a secondary sequence from the second set of secondary sequences for transmitting the sl-BP-RS(s).

In some embodiments of the present application, the method further includes scrambling each sl-BP-RS by an RNTI dedicated for sidelink beam pairing.

According to some other embodiments of the present application, a method performed by a UE may include: obtaining configuration information for beam pairing based on configuration or pre-configuration, wherein the configuration information includes at least one of: a configuration for S-BPB; a configuration for sl-BP-RS; a configuration for sl-BP-FB; or association pattern(s) between occasions for sl-BP-RS and sl-BP-FB; receiving sl-BP-RS(s) based on the obtained configuration information in response to the UE becoming a UE for transmitting sl-BP-FB(s); determining one or more sl-BP-RSs within the received sl-BP-RS(s) and beam(s) receiving the one or more sl-BP-RSs; determining resource(s) for transmitting the sl-BP-FB(s) based on the obtained configuration information and the one or more sl-BP-RSs; and transmitting the sl-BP-FB(s) on the determined resource(s).

In some embodiments of the present application, determining resource(s) for transmitting the sl-BP-FB(s) includes determining one or more occasions for S-BPB based on the configuration for S-BPB and the one or more sl-BP-RSs.

In some embodiments of the present application, the configuration for sl-BP-FB includes an association between sequences for sl-BP-RS and sl-BP-FB, and determining resource(s) for transmitting the sl-BP-FB(s) includes determining a primary sequence and a secondary sequence based on the one or more sl-BP-RSs and the association between sequences for sl-BP-RS and sl-BP-FB.

In some embodiments of the present application, the configuration for sl-BP-FB indicates at least one of the following: a duration of a sidelink beam pairing feedback period in a resource pool for sidelink transmission; an offset of a starting point of a sidelink beam pairing feedback period relative to a reference point, wherein the reference point is one of: (1) a first slot of the resource pool; (2) a starting point of a sidelink beam pairing period; or (3) an end point of a sidelink beam pairing period; or a frequency position for sl-BP-FB in the resource pool.

In some embodiments of the present application, determining resource(s) for transmitting the sl-BP-FB(s) includes determine one or more occasions in the sidelink beam pairing feedback period based on the configuration for sl-BP-FB and the one or more sl-BP-RSs.

In some embodiments of the present application, the method further includes scrambling each sl-BP-FB by an RNTI dedicated for sidelink beam pairing.

According to some other embodiments of the present application, a method performed by a BS may include: transmitting configuration information for beam pairing, wherein the configuration information includes at least one of: a configuration for S-BPB; a configuration for sl-BP-RS; a configuration for sl-BP-FB; or association pattern(s) between occasions for sl-BP-RS and sl-BP-FB.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary beam paring procedure for beam-based communication between two sidelink UEs according to some embodiments of the present application;

FIG. 3 illustrates an exemplary S-BPB slot according to some embodiments of the present application;

FIG. 4 illustrates an exemplary distribution of occasions for S-BPB according to some embodiments of the present application;

FIG. 5 illustrates exemplary relations between a sidelink beam pairing period and an S-SSB period according to some embodiments of the present application;

FIG. 6 illustrates an exemplary association pattern according to some embodiments of the present application;

FIG. 7 illustrates another exemplary association pattern according to some embodiments of the present application;

FIG. 8 illustrates another exemplary association pattern according to some embodiments of the present application;

FIG. 9 illustrates another exemplary association pattern according to some embodiments of the present application;

FIG. 10 illustrates a flowchart of an exemplary method for beam pairing according to some embodiments of the present application; and

FIG. 11 illustrates a simplified block diagram of an exemplary apparatus for beam pairing according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

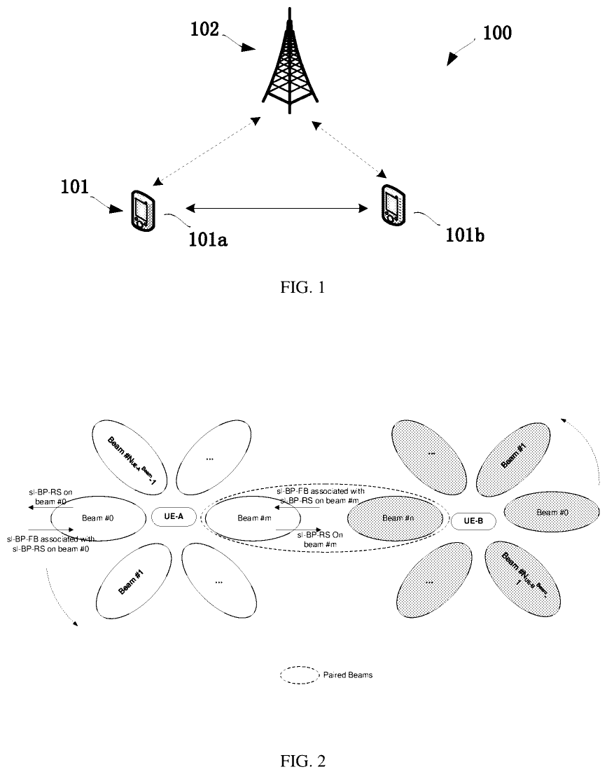

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 101 may include wearable devices, such as smart watches, fitness bands, optical head-mounted displays, or the like.

According to some embodiments of the present application, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high-altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

In a cell search procedure, a UE (e.g., UE 101a or UE 101b) may acquire the time and frequency synchronization to a cell and determine a physical layer ID of the cell by searching for primary synchronization signal (PSS) and secondary synchronization signal (SSS) and decoding physical broadcast channel (PBCH) carried by synchronization signal (SS)/PBCH block (SSB).

The PBCH may carry a master information block (MIB), which is an integrated part of the SSB and is used for signaling the most essential system information related to access to the cell, e.g., the frequency position and timing of the cell. In order to enable the UE to monitor a physical downlink control channel (PDCCH) scheduling a physical downlink shared channel (PDSCH) carrying system information block 1 (SIB1), MIB provides the needed configuration for monitoring the PDCCH in pdcch-ConfigSIB1 as specified in 3GPP standard documents.

In an initial access procedure in NR Uu beamforming scenario, a BS may transmit one or more SSBs to a UE, and each SSB of the one or more SSBs is transmitted with a different beam. After receiving the one or more SSBs, the UE may select an SSB satisfying a certain condition from the one or more SSBs. Then, the UE may transmit a random access preamble in a random access channel occasion (RO) associated with the selected SSB over a physical random access channel (PRACH), thereby indicating the selected SSB to the BS. Specifically, an RO is a time-frequency resource for transmitting the random access preamble. The information for determining RO(s) and association between SSB(s) and RO(s) are indicated in SIB1.

In sidelink evolution, sidelink beam management may be one objective which needs to be studied. The sidelink beam management may include initial beam pairing, beam maintenance, and beam failure recovery. Specifically, the initial beam pairing may include selecting beam-pair(s) to be used for subsequent communication between two sidelink UEs.

As described above, the initial access procedure in NR Uu beamforming scenario is performed by employing SSB and feedback over PRACH. Although S-SSB is also used for synchronization on sidelink, the aforementioned method employing SSB and feedback may not be applied for the sidelink beam pairing procedure due to the following reasons: (1) in a synchronization procedure between a UE and a synchronization reference UE (i.e., SyncRef UE) in NR vehicle to everything (V2X), there is no feedback resources for the UE to indicate the selected S-SSB back to the SyncRef UE; and (2) since the sidelink resources are determined based on sensing, transmitting feedback over PRACH may introduce intolerable processing latency for initial beam pairing or beam failure recovery. Given this, the method of transmitting feedback over PRACH is complicated for NR V2X and is not applicable to be used in NR V2X. Then, how to design a beam pairing procedure for sidelink needs to be addressed.

Embodiments of the present application provide improved solutions for SL beam management, which propose configurations, signalings, and procedures for sidelink beam pairing. More details will be described in the following text in combination with the appended drawings.

FIG. 2 illustrates an exemplary beam paring procedure for beam-based communication between two sidelink UEs according to some embodiments of the present application. In some embodiments of the present application, the beam-based sidelink communication may be performed in frequency range 2 (FR2) as specified in 3GPP standard documents. It is contemplated that the methods described in the embodiments of the present application may also be performed in new frequency ranges which can be extended to or complemented in future 3GPP releases.

Referring to FIG. 2, in a beam-based sidelink unicast transmission scenario, a UE-A and a UE-B may use directional beams when transmitting and receiving over sidelink. For example, the UE-A incudes N_{UE-A}^{Beam} beams (e.g., beam #0, beam #1, . . . , and beam #N_{UE-A}^{Beam}−1), and the UE-B includes N_{UE-B}^{Beam} beams (e.g., beam #0, beam #1, . . . , and beam #N_{UE-B}^{Beam}−1). Given this, before performing sidelink communications therebetween, the UE-A and the UE-B need to identify beam pair(s) (e.g., beam #m of the UE-A and beam #n of the UE-B) through a beam pairing procedure such that the identified beam pair(s) can be used for subsequent communications. Specifically, during the beam pairing procedure, the beam pair(s) may be identified by transmitting and receiving sl-BP-RS and sl-BP-FB between the UE-A and the UE-B. For example, as shown in FIG. 2, the UE-A may transmit an sl-BP-RS on each of beam #0, beam #1, . . . , and beam #N_{UE-A}^{Beam}−1 of the UE-A to the UE-B. The UE-B may receive the sl-BP-RSs from the UE-A with each of beam #0, beam #1, . . . , and beam #N_{UE-B}^{Beam}−1 of the UE-B, and select sl-BP-RS(s) (e.g., sl-BP-RSs on beam #m of the UE-A) satisfying a certain condition. The beam(s) of the UE-B (e.g., beam #n of the UE-B) on which the selected sl-BP-RS(s) is(are) received will be used for subsequent communications between the UE-A and the UE-B. The UE-B may transmit sl-BP-FB(s) associated with the selected sl-BP-RS(s) to indicate the selected sl-BP-RS(s) to the UE-A. Then, the UE-A may receive the sl-BP-FB(s) and identify the selected sl-BP-RS(s) based on the received sl-BP-FB(s). The UE-A may also identify the beam(s) of the UE-A (e.g., beam #m of the UE-A) associated with the selected sl-BP-RS(s) (i.e., the beam(s) on which the selected sl-BP-RS(s) is(are) transmitted). The identified beam(s) will be used for subsequent communications between the UE-A and the UE-B. In this way, the beam pair(s) used for subsequent communications may be identified. In some embodiments of the present application, the sl-BP-FB may also be referred to as sidelink beam pairing report.

In order to perform the beam paring procedure, some configuration information may be needed. In some embodiments of the present application, a sidelink UE (e.g., UE-A or UE-B) may obtain configuration information for beam pairing based on configuration or pre-configuration. The configuration information for beam pairing may include at least one of: a configuration for S-BPB; a configuration for sl-BP-RS; a configuration for sl-BP-FB; or association pattern(s) between occasions for sl-BP-RS and sl-BP-FB.

In some embodiments of the present application, obtaining the configuration information based on configuration (i.e., the configuration information is configured for a UE) may refer to that: the configuration information is transmitted by a BS to the UE via a signaling, e.g., a system information block (SIB), a master information block (MIB), a radio resource control (RRC) signaling, a medium access control (MAC) layer control element (CE), or downlink control information (DCI), such that the UE may receive the configuration information from the BS. In an embodiment of the present application, obtaining the configuration information based on configuration may apply to the scenario where the UE is in coverage of a network.

In some embodiments of the present application, obtaining the configuration information based on pre-configuration (i.e., the configuration information is pre-configured for a UE) may refer to that: the configuration information may be hard-wired into the UE or stored on a subscriber identity module (SIM) or universal subscriber identity module (USIM) card for the UE, such that the UE may obtain the configuration information within the UE. In an embodiment of the present application, obtaining the configuration information based on pre-configuration may apply to the scenario where the UE is out of coverage of the network.

According to some embodiments of the present application, an S-BPB may be used to transmit an sl-BP-RS or an sl-BP-FB. The S-BPB may be designed based on S-SSB.

For example, an S-BPB may occupy one slot in the time domain and uses the same numerology as the one configured or pre-configured in the SL bandwidth part (BWP), i.e., using the same numerology as the one for physical sidelink control channel (PSCCH) and physical sidelink shared channel (PSSCH). An S-BPB may include a physical sidelink broadcast channel (PSBCH), a primary sequence and a secondary sequence. In some embodiments of the present application, for a normal CP, the PSBCH, the primary sequence, and the secondary sequence are carried in the first 13 symbols of an S-BPB slot (i.e., a slot used to carry an S-BPB). In some embodiments of the present application, for an extended CP, the PSBCH, the primary sequence, and the secondary sequence are carried in the first 11 symbols of an S-BPB slot. The last symbol in an S-BPB slot is used as a guard symbol.

An S-BPB is not frequency multiplexed with any other sidelink physical channel within the SL BWP, i.e., S-BPBs are not transmitted in the slots of a resource pool for sidelink transmission. The frequency location of an S-BPB is configured or pre-configured within the SL BWP. As a result, a UE does not need to perform blind detection in the frequency domain to find an S-BPB. The bandwidth of an S-BPB may also be configured or pre-configured for the UE. For example, the bandwidth of an S-BPB (hereinafter referred to as S-BPB bandwidth) may span 11 common resource blocks (RBs) within the SL BWP. Since an RB consists of 12 subcarriers, the S-BPB bandwidth spans 11×12=132 subcarriers. However, the bandwidth of an S-BPB may be any other values in some other embodiments of the present application.

In some embodiments of the present application, each of the primary sequence and the secondary sequence may include a sequence of 127 bits. The primary sequence and the secondary sequence are modulated with binary phase shift keying (BPSK) such that each sequence occupies 127 subcarriers in a symbol within the S-BPB bandwidth, which are from the third subcarrier relative to the start of the S-BPB bandwidth up to the 129th subcarrier.

In some embodiments of the present application, for a normal CP, the PSBCH may be transmitted on the first symbol and eight symbols after the primary sequence and the secondary sequence in an S-BPB slot. In some embodiments of the present application, for an extended CP, the PSBCH may be transmitted on the first symbol and six symbols after the primary sequence and the secondary sequence in an S-BPB slot. The first symbol (i.e., the first PSBCH symbol) of the S-BPB is used for automatic gain control (AGC). For a given CP, the structure of an S-BPB slot is fixed.

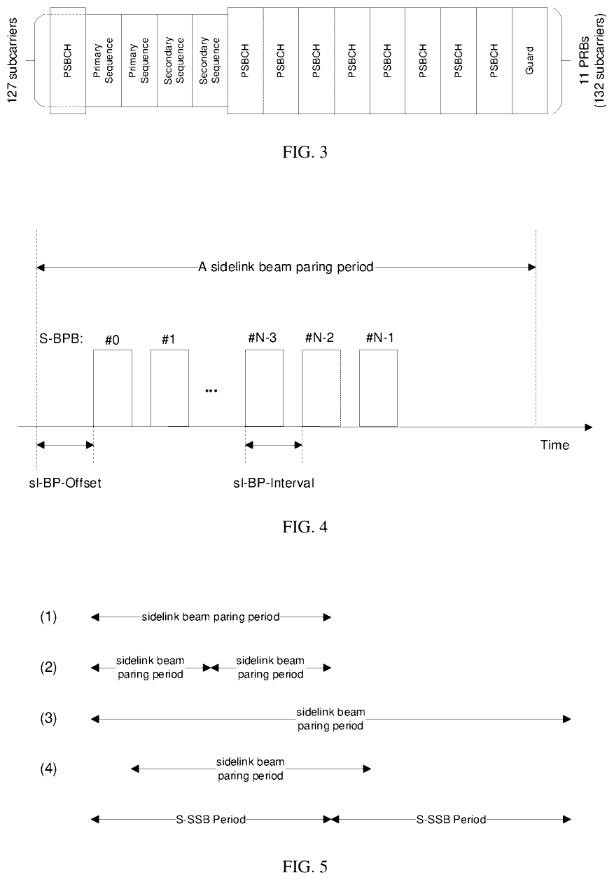

FIG. 3 illustrates an exemplary S-BPB slot according to some embodiments of the present application. In the embodiments of FIG. 3, the normal CP is used.

Referring to FIG. 3, the S-BPB occupies one slot in the time domain and occupies 11 RBs (i.e., 132 subcarriers) in the frequency domain (i.e., the S-BPB bandwidth M_{S-BPB}=11 RBs=132 subcarriers). In the example of FIG. 3, the S-BPB slot may include 14 OFDM symbols in total. The primary sequence is transmitted repeatedly on the second and third symbols in the S-BPB slot. The secondary sequence is transmitted repeatedly on the fourth and fifth symbols in the S-BPB slot. The PSBCH is transmitted on the first symbol and eight symbols after the secondary sequence in the S-BPB slot. The PSBCH in the first symbol of the S-BPB slot is used for AGC. The last symbol in the S-BPB slot is used as a guard symbol.

According to some embodiments of the present application, the configuration for S-BPB may indicate at least one of:
a duration of a sidelink beam pairing period for S-BPB.
a sidelink beam pairing offset for S-BPB;
a sidelink beam pairing interval for S-BPB; or
a number of S-BPBs per sidelink beam pairing period.

For example, the configuration for S-BPB may include four parameters, e.g., sl-BP-Period, sl-BP-Offset, sl-BP-Interval, and N_{S-BPB}.

The parameter sl-BP-Period may indicate a duration of a sidelink beam pairing period for S-BPB. A sidelink beam pairing period may start from the first slot of a frame with a system frame number (SFN) such that the SFN mod NumFrame(sl-BP-Period)=0, wherein sl-BP-Period may be represented in number of ms or frame, and NumFrame(*) is a function to obtain the number of frames of a parameter.

The parameter sl-BP-Offset may indicate a sidelink beam pairing offset for S-BPB. Specifically, the sidelink beam pairing offset may refer to an offset in time of the first S-BPB within a sidelink beam pairing period relative to the first slot of the sidelink beam pairing period. The parameter sl-BP-Offset may be represented in number of frame, slot or ms.

The parameter sl-BP-Interval may indicate a sidelink beam pairing interval for S-BPB. Specifically, the sidelink beam pairing interval may refer to an interval between two adjacent occasions for S-BPBs within a sidelink beam pairing period. The parameter sl-BP-Interval may be represented in number of frame, slot or ms.

The parameter N_{S-BPB} may indicate a number of S-BPBs per sidelink beam pairing period.

Based on the configuration for S-BPB, the UE (e.g., UE-A or UE-B) may determine a distribution of occasions for S-BPB.

FIG. 4 illustrates an exemplary distribution of occasions for S-BPB according to some embodiments of the present application. Specifically, in FIG. 4, the number of S-BPBs within a sidelink beam pairing period is N and the occasion for each S-BPB includes one slot in the time domain. FIG. 4 also shows a sidelink beam pairing offset for S-BPB (sl-BP-Offset) and a sidelink beam pairing interval for S-BPB (sl-BP-Interval).

The parameters in the configuration for S-BPB (i.e., at least one of: a duration of a sidelink beam pairing period for S-BPB; a sidelink beam pairing offset for S-BPB; a sidelink beam pairing interval for S-BPB; or a number of S-BPBs per sidelink beam pairing period) may be either as same as or different from those in a configuration for S-SSB.

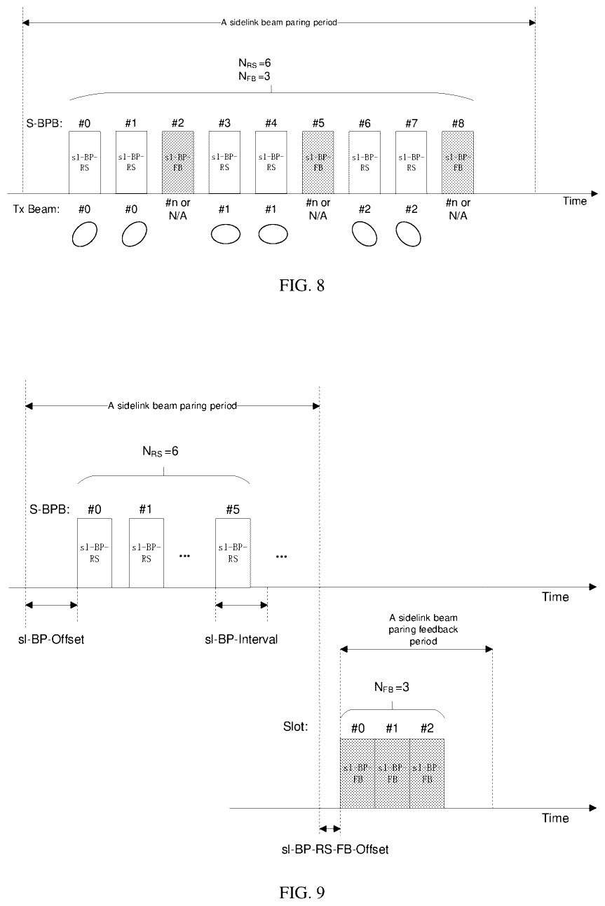

For example, FIG. 5 illustrates exemplary relations between a sidelink beam pairing period and an S-SSB period according to some embodiments of the present application. Two consecutive S-SSB periods are illustrated at the bottom of FIG. 9 as a reference.

Referring to FIG. 5, in case (1), the duration for a sidelink beam pairing period and the duration for an S-SSB period are the same and their boundaries are aligned with each other, which may decrease the complexity in some cases.

In case (2), the duration for a sidelink beam pairing period is a half of the duration for an S-SSB period.

In case (3), the duration for a sidelink beam pairing period is double of the duration for an S-SSB period.

In case (4), the duration for a sidelink beam pairing period and the duration for an S-SSB period are the same, but the boundaries of the sidelink beam pairing period are not aligned with those of the S-SSB Period.

In some embodiments, the primary sequence and the secondary sequence included in an S-BPB may be similar to sidelink primary synchronization signal (S-PSS) and sidelink secondary synchronization signal (S-SSS) in an S-SSB, respectively.

Specifically, for an S-SSB, 2 candidate m-sequences of 3 candidate m-sequences (e.g., the indexes thereof are 0, 1, and 2, respectively) defined in NR are used for S-PSS in an S-SSB and 336 candidate gold sequences (e.g., the indexes thereof are 0-335, respectively) defined in NR are used for S-SSS in an S-SSB. It is assumed that the set of indexes (N_{S-PSS}) of m-sequences used for S-PSS is {0,1}, and the set of indexes (N_{S-SSS}) of gold sequences used for S-SSS is {0, . . . , 335}.

In some embodiments of the present application, a sequence ID (which is determined as a combination of an index of a primary sequence and an index of a secondary sequence) can be used to distinguish S-SSB and S-BPB. For example, the remaining one candidate m-sequence defined in NR which is not used for S-PSS can be used for the primary sequence of S-BPB. In other words, the set of indexes (N_{S-BPB, P}) of m-sequences used for the primary sequence of S-BPB is {2}. In some embodiments of the present application, 336 candidate gold sequences for S-SSS may also be used for the secondary sequence of S-BPB. In other words, the set of indexes (N_{S-BPB, s}) of gold sequences used for the secondary sequence of S-BPB is {0, . . . , 335}. In an embodiment, the sequence ID for S-SSB=336*N_{S-PSS}+N_{S-SSS}, which is within the range between 0 and 671; and the sequence ID for S-BPB=336*N_{S-BPB, P}+N_{S-BPB, S}, which is within the range between 672 and 1007.

In some other embodiments of the present application, an S-BPB may be distinguished from an S-SSB by contents conveyed in the S-BPB, and the sequences used for primary and secondary sequences of S-BPB may be the same as those used for S-PSS and S-SSS of S-SSB.

According to some embodiments of the present application, the configuration for sl-BP-RS may include a first set of primary sequences and a second set of secondary sequences for sl-BP-RS. An sl-BP-RS may use one primary sequence from the first set of primary sequences and one secondary sequence from the second set of secondary sequences. For example, the first set of primary sequences may include the candidate m-sequence indexed with 2 as defined in NR, and the second set of secondary sequences may include the candidate gold sequences with indexes in the set of {0, . . . , 335} as defined in NR. It is contemplated that the first set of primary sequences and the second set of secondary sequences for sl-BP-RS may include other sequences, not limited to those described herein.

According to some embodiments of the present application, the configuration for sl-BP-RS may also indicate that an sl-BP-RS includes at least one of the following contents:
Type information indicating sl-BP-RS or sl-BP-FB. In an embodiment, the type information may include 1 bit or 2 bits. For example, in the case that the S-BPB is distinguished from the S-SSB by the content in the S-BPB, the type information includes 2 bits. In some embodiments of the present application, the 2 bits may reuse the reserved 2 bits as specified in an S-SSB. Otherwise, the type information includes 1 bit.
An ID of a UE transmitting the sl-BP-RS. In an embodiment, the ID of the UE may include 8 bits. For example, the ID of the UE may be a layer-1 ID.
A number of beams for transmitting the sl-BP-RS.
A repetition number of each beam for transmitting the sl-BP-RS.
An association pattern within the association pattern(s) between occasions for sl-BP-RS and sl-BP-FB in the configuration information.
Information indicating whether a beam correspondence is enabled on the UE transmitting the sl-BP-RS. In an embodiment, such information may include 1 bit.
A priority of an intended traffic.
Cyclic redundancy check (CRC). In an embodiment, the CRC may include 24 bits.

In some embodiments, the above contents of the sl-BP-RS may be carried by PSBCH(s) in an S-BPB. In some embodiments, the PSBCH may occupy the same symbols in an S-BPB slot as PSBCH in an S-SSB slot. In an embodiment, the payload size of PSBCH in an S-BPB may be the same as that of PSBCH in an S-SSB, i.e., 56 bits. That is, the total number of bits of the contents included in the PSBCH is no more than 56 bits.

According to some embodiments of the present application, an sl-BP-FB may be carried by an S-BPB. In such embodiments, the configuration for sl-BP-FB may include an association between sequences for sl-BP-RS and sl-BP-FB. In some embodiments of the present application, the association may include at least one of: a first offset or a second offset. The first offset may refer to an offset between indexes of a primary sequence for sl-BP-RS and a primary sequence for sl-BP-FB, and the second offset may refer to an offset between indexes of a secondary sequence for sl-BP-RS and a secondary sequence for sl-BP-FB. For example, in the case that the first offset is 0 and the second offset is 168, for an sl-BP-RS including a primary sequence which is the candidate m-sequence indexed with 2 and a secondary sequence which is the candidate gold sequence indexed with 3, the associated sl-BP-FB includes a primary sequence which is the candidate m-sequence indexed with 2 and a secondary sequence which is the candidate gold sequence indexed with 171.

In an embodiment of the present application, the second offset may be 0. In such embodiment, the second set of secondary sequences for sl-BP-RS may include the candidate gold sequences with indexes in the set of {0, . . . , 335} and a set of secondary sequences for sl-BP-FB may also include the candidate gold sequences with indexes in the set of {0, . . . , 335}. In another embodiment of the present application, the second offset may be 168. In such embodiment, the second set of secondary sequences for sl-BP-RS may include the candidate gold sequences with indexes in the set of {0, . . . , 167} and a set of secondary sequences for sl-BP-FB may include the candidate gold sequences with indexes in the set of {168, . . . , 335}.

In some embodiments of the present application, the association may include an offset between sequence IDs (which is determined as a combination of an index of a primary sequence and an index of a secondary sequence) for sl-BP-RS and sl-BP-FB.

In such embodiments, an sl-BP-FB is carried by an S-BPB, and the configuration for sl-BP-FB may also indicate that an sl-BP-FB includes at least one of the following contents:
Type information indicating sl-BP-RS or sl-BP-FB. In an embodiment, the type information may include 1 bit or 2 bits. For example, in the case that the S-BPB is distinguished from the S-SSB by the content in the S-BPB, the type information includes 2 bits. In some embodiments of the present application, the 2 bits may reuse the reserved 2 bits as specified in an S-SSB. Otherwise, the type information includes 1 bit.
An ID of a UE transmitting the sl-BP-FB. In an embodiment, the ID of the UE may include 16 bits. For example, the ID of the UE is a layer-1 ID.
An sl-BP-RS occasion indicator.
Information indicating whether a beam associated with an occasion for sl-BP-RS indicated by the sl-BP-RS occasion indicator is a primary beam or a secondary beam. In an embodiment, such information may include 1 bit.
Information indicating an RSRP measured on the beam associated with the occasion for sl-BP-RS indicated by the sl-BP-RS occasion indicator.
Information indicating whether a beam correspondence is enabled on the UE transmitting the sl-BP-FB. In an embodiment, such information may include 1 bit.
CRC. In an embodiment, the CRC may include 24 bits.

In some embodiments, the above contents of sl-BP-FB may be carried by PSBCH(s) in an S-BPB. In an embodiment, the payload size of PSBCH in an S-BPB may be the same as that of PSBCH in an S-SSB, i.e., 56 bits. That is, the total number of bits of the contents included in the PSBCH is no more than 56 bits.

According to some other embodiments of the present application, an sl-BP-FB may be carried by sidelink transmission including at least one of PSCCH or PSSCH. In such embodiments, the configuration for sl-BP-FB may indicate at least one of the following:
a duration of a sidelink beam pairing feedback period in a resource pool for sidelink transmission (e.g., indicated by a parameter sl-BP-FB period);
an offset of a starting point of a sidelink beam pairing feedback period relative to a reference point (e.g., indicated by a parameter sl-BP-RS-FB-Offset), wherein the reference point is one of: (1) a first slot of the resource pool; (2) a starting point of a sidelink beam pairing period; or (3) an end point of a sidelink beam pairing period; or
a frequency position for sl-BP-FB in the resource pool.

In such embodiments, the configuration for sl-BP-FB may also indicate that an sl-BP-FB includes at least one of the following contents:
Type information indicating sl-BP-RS or sl-BP-FB.
An ID of a UE transmitting the sl-BP-FB. In an embodiment, the ID of the UE may include 16 bits. For example, the ID of the UE is a layer-1 ID.
An ID of a UE transmitting the sl-BP-RS associated with the sl-BP-FB. In an embodiment, the ID of the UE may include 8 bits. For example, the ID of the UE is a layer-1 ID.
An sl-BP-RS occasion indicator.
Information indicating whether a beam associated with an occasion for sl-BP-RS indicated by the sl-BP-RS occasion indicator is a primary beam or a secondary beam. In an embodiment, such information may include 1 bit.
Information indicating an RSRP measured on the beam associated with the occasion for sl-BP-RS indicated by the sl-BP-RS occasion indicator.
Information indicating whether a beam correspondence is enabled on the UE transmitting the sl-BP-FB. In an embodiment, such information may include 1 bit.

In some embodiments of the present application, the first three items of the above contents may be included in sidelink control information (SCI) (e.g., 1^{st}-stage SCI or 2^{nd}-stage SCI) of a sidelink transmission, and the remaining items may be included in a PSSCH of the sidelink transmission. For example, the remaining items may be transmitted via a medium access control (MAC) control element (CE).

Each association pattern included in the configuration information for beam pairing may include at least one of:
an association pattern index;
a repetition flag indicating a repetition order of sl-BP-RSs on beams, for example:
   1) the value of the repetition flag being “off” indicates that: sl-BP-RSs are first transmitted on different beams in an increasing order of beam indexes until reaching N_{Tx}^{Beam} (wherein N_{Tx}^{Beam} is the number of beams for transmitting sl-BP-RSs); then such transmissions are repeated for (N_{Repetition}^{Beam}−1) times (wherein N_{Repetition}^{Beam} is a repetition number of each beam for transmitting sl-BP-RSs); and
   2) the value of the repetition flag being “on” indicates that: the sl-BP-RSs are transmitted repeatedly on one beam until reaching N_{Repetition}^{Beam} times; then the sl-BP-RSs are transmitted repeatedly on the next beam until reaching N^{Repetition}_{Beam} times; the procedure continues until reaching N_{Tx}^{Beam} beams;
an order flag indicating an order of transmissions of sl-BP-RS(s) and sl-BP-FB(s), for example:
   1) the value of the order flag being “0” indicates that the occasions for sl-BP-FBs are located after all occasions for sl-BP-RSs; and
   2) the value of the order flag being “1” indicates that the occasions for sl-BP-RS(s) and sl-BP-FB(s) are located in a staggered way. In an embodiment, every N_{Tx}^{Beam} occasions for sl-BP-RS on different beams are followed by N_{Tx}^{Beam} occasions for sl-BP-FB. Specifically, this case occurs when the repetition flag is set as “off”. In another embodiment, every N_{Repetition}^{Beam} occasions for sl-BP-RS on one beam are followed by one occasion for sl-BP-FB. Specifically, this case occurs when the repetition flag is set as “on”.
a maximum number of sl-BP-RS occasion indicators (i.e., a maximum number of selected sl-BP-RSs) to be reported by a UE for transmitting sl-BP-FB(s), which is an integer such as 0, 1, 2, etc.; or
a stop flag indicating a stop condition of transmissions of sl-BP-RS(s) and sl-BP-FB(s), for example:
   1) the value of the stop flag being “0” indicates that the transmissions are stopped when all intended RSs and FBs are transmitted, and
   2) the value of the stop flag being “1” indicates that the transmissions are stopped when the maximum number of sl-BP-RS occasion indicators are indicated to a UE transmitting sl-BP-RS(s) or when all intended RSs and FBs are transmitted.

The following Table 1 illustrates three exemplary association patterns included in the configuration information for beam pairing. The association patterns illustrated in Table 1 may be applied for the cases that both sl-BP-RS(s) and sl-BP-FB(s) are carried by S-BPBs.

TABLE 1

| | | | Maximum Number of SI-BP- | |
|---|---|---|---|---|
| Association | Repetition | Order | RS Occasion Indicators | Stop |
| Pattern Index | Flag | Flag | to Be Reported | Flag |
| #1 | Off | 0 | 1 | 0 |
| #2 | On | 0 | 1 | 0 |
| #3 | On | 1 | 1 | 1 |

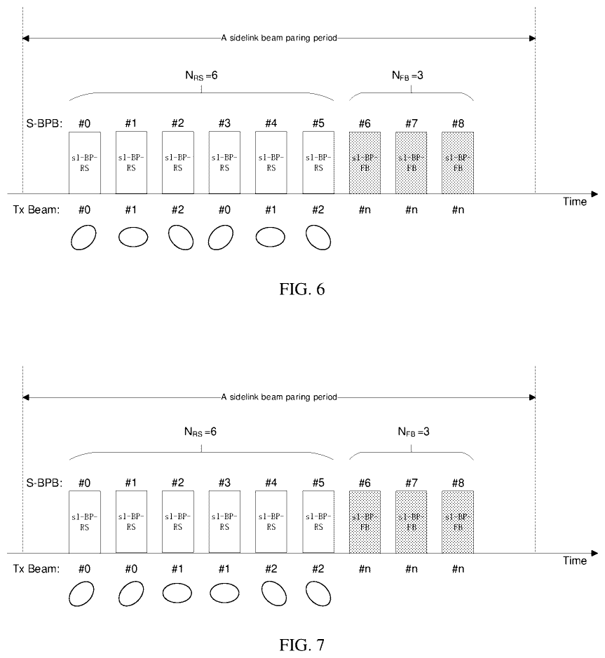

FIG. 6 illustrates an example of association pattern #1 listed in the above Table 1 according to some embodiments of the present application.

In the example of FIG. 6, it is assumed that a number of beams (i.e., N_{Tx}^{Beam} for transmitting sl-BP-RS is 3 and a repetition number (i.e., N_{Repetition}^{Beam}) of each beam for transmitting sl-BP-RS is 2. Based on N_{Tx}^{Beam} and N_{Repetition}^{Beam}, a UE may determine a number of occasions (or S-BPBs) for transmitting sl-BP-RSs (e.g., N_{RS}). For example, the number of occasions for transmitting sl-BP-RSs may be determined by N_{TX}^{Beam}×N_{Repetition}^{Beam}. Accordingly, a UE (e.g., UE-A or UE-B) may determine 6 (i.e., 3×2) occasions used for transmitting sl-BP-RSs.

The maximum number (i.e., Nₘₐₓ) of sl-BP-RS occasion indicators to be reported may be used for determining the number of occasions for transmitting sl-BP-FBs. For example, the number of occasions (or S-BPBs) for transmitting sl-BP-FBs (e.g., N_{FB}) may be determined by Nₘₐₓ×N_{Tx}^{Beam}. Accordingly, in the example of FIG. 6, the UE may determine that 3 occasions are used for transmitting sl-BP-FBs.

The above 9 occasions for transmitting sl-BP-RSs and sl-BP-FBs may be indexed with #0, #1, #2, . . . , #8.

In association pattern #1, the order flag is “0,” which indicates that 3 occasions for transmitting sl-BP-FBs are after the 6 occasions for transmitting sl-BP-RSs. That is, occasions #0 to #5 are used for transmitting sl-BP-RSs and occasions #6 to #8 are used for transmitting sl-BP-FBs.

In association pattern #1, the repetition flag is “off,” which means that the sl-BP-RSs are first transmitted on different beams, i.e., occasions #0 to #2 are used for transmitting sl-BP-RSs on beams #0 to #2 respectively. Then, such transmitting order may repeat one more time, i.e., occasions #3 to #5 are used for transmitting sl-BP-RSs on beams #0 to #2 respectively.

In association pattern #1, the stop flag is “0,” which means that the transmissions are stopped when all the 6 sl-BP-RSs and 3 sl-BP-FBs are transmitted.

FIG. 7 illustrates an example of association pattern #2 listed in the above Table 1 according to some embodiments of the present application.

The only difference between association pattern #2 and association pattern #1 is: in association pattern #2, the repetition flag is “on,” which means that the sl-BP-RSs are repeatedly transmitted twice on one beam, and then repeatedly transmitted on the next beam. That is, occasions #0 and #1 are used for transmitting sl-BP-RSs on beam #0, occasions #2 and #3 are used for transmitting sl-BP-RSs on beam #1, and occasions #4 and #5 are used for transmitting sl-BP-RSs on beam #2.

FIG. 8 illustrates an example of association pattern #3 listed in the above Table 1 according to some embodiments of the present application.

The differences between association pattern #3 and association pattern #1 are:
1) In association pattern #3, the repetition flag is “on,” which means that the sl-BP-RSs are repeatedly transmitted twice on one beam, and then repeatedly transmitted on the next beam. The order flag is “1”, which indicates that the sl-BP-FBs are transmitted after the transmissions of sl-BP-RS(s) on each beam.
   Given the above, the UE may determine that: occasions #0 and #1 are used for transmitting sl-BP-RSs on beam #0, occasion #2 is used for transmitting sl-BP-FB, occasions #3 and #4 are used for transmitting sl-BP-RSs on beam #1, occasion #5 is used for transmitting sl-BP-FB, occasions #6 and #7 are used for transmitting sl-BP-RSs on beam #2, and occasion #8 is used for transmitting sl-BP-FB.
2) In association pattern #3, the stop flag is “1,” which indicates that the transmissions are stopped when the maximum number of sl-BP-RS occasion indicators are reported or when all intended sl-BP-RSs and sl-BP-FBs are transmitted.
   For example, on occasions #0 and #1, UE-A may transmit two sl-BP-RSs on beam #0 of UE-A, respectively. UE-B may scan with beam #n and beam #n+1 and determine if any measured RSRP satisfies a selection condition. If a measured RSRP on a beam (e.g., beam #n of UE-B) on an occasion for sl-BP-RS (e.g., occasion #0) satisfies the selection condition, UE-B may transmit an sl-BP-FB on the beam (e.g., beam #n) of UE-B on occasion #2, and the sl-BP-FB may include or may not include an sl-BP-RS occasion indicator indicating occasion #0. In such case, since the maximum number (i.e., 1) of sl-BP-RS occasion indicators is reported by the sl-BP-FB, transmissions of sl-BP-RS and sl-BP-FB are stopped. Otherwise, if no measured RSRP satisfies the selection condition, no sl-BP-FB is transmitted (which is referred to as N/A in FIG. 8) on occasion #2. Then, UE-A may transmit two sl-BP-RSs on beam #1 of UE-A on occasions #3 and #4, respectively. UE-B may continue to scan with beam #n and beam #n+1 and determine if any measured RSRP satisfies the selection condition to determine whether to transmit an sl-BP-FB on occasion #5. The transmissions may continue until the maximum number of sl-BP-RS occasion indicators is reported or when all intended sl-BP-RSs and sl-BP-FBs are transmitted.

The association patterns listed in Table 1 are only for illustrative purpose. It is contemplated that the association patterns may include other patterns according to some other embodiments of the present application.

In the cases that sl-BP-RS(s) are carried by S-BPBs and sl-BP-FB(s) are carried by sidelink transmission, the sl-BP-FB(s) may always be transmitted after all the transmissions of sl-BP-RS(s). In such cases, the association patterns may not include the order flag and the stop flag.

For example, the following Table 2 illustrates an exemplary association pattern included in the configuration information for beam pairing. The association pattern illustrated in Table 2 may be applied for the cases that sl-BP-RS(s) are carried by S-BPBs and sl-BP-FB(s) are carried by sidelink transmission.

TABLE 2

| Association | Repetition | Maximum Number of SI-BP-RS Occasion |
|---|---|---|
| Pattern Index | Flag | Indicators to Be Reported |
| #4 | Off | 1 |

FIG. 9 illustrates an example of association pattern #4 listed in the above Table 2 according to some embodiments of the present application.

In the example of FIG. 9, it is assumed that a number of beams (i.e., N_{Tx}^{Beam} for transmitting sl-BP-RS is 3 and a repetition number (i.e., N_{Repetition}^{Beam}) of each beam for transmitting sl-BP-RS is 2. Accordingly, a UE (e.g., UE-A or UE-B) may determine that 6 occasions (or S-BPBs) are used for transmitting sl-BP-RSs.

In association pattern #4, the maximum number of sl-BP-RS occasion indicators to be reported is 1, and thus the UE may determine that 3 occasions (e.g., slots) within a sidelink beam pairing feedback period in a resource pool are used for transmitting sl-BP-FBs.

In association pattern #4, the repetition flag is “off,” which means that the sl-BP-RSs are first transmitted on different beams, i.e., occasions #0 to #2 are used for transmitting sl-BP-RSs on beams #0 to #2 respectively. Then, such transmitting order may repeat one more time, i.e., occasions #3 to #5 are used for transmitting sl-BP-RSs on beams #0 to #2 respectively.

The association pattern in Table 2 is only for illustrative purpose. It is contemplated that the association patterns may include other patterns according to some other embodiments of the present application.

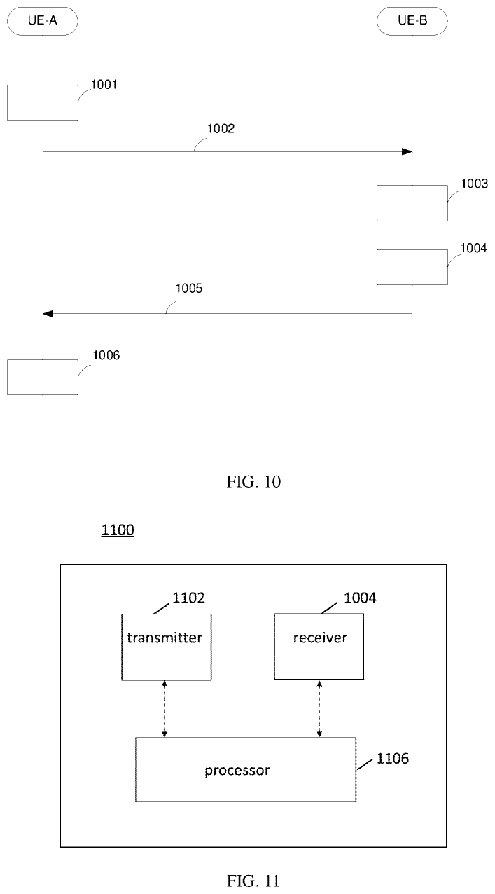

FIG. 10 illustrates a flowchart of an exemplary method for beam pairing according to some embodiments of the present application. The method illustrated in FIG. 10 may be performed by two sidelink UEs (e.g., UE-A and UE-B). Although the method is illustrated in a system level, persons skilled in the art can understand that the method implemented in the two sidelink UEs can be separately implemented and incorporated in other apparatus with the like functions. It is contemplated that, before the steps illustrated in FIG. 10, the UE-A and the UE-B may obtain configuration information for beam pairing (e.g., any of the configuration information described above) based on configuration or pre-configuration.

Referring to FIG. 10, in step 1001, the UE-A may determine resource(s) for transmitting sl-BP-RS(s) based on the obtained configuration information in response to the UE-A becoming a UE for transmitting sl-BP-RS(s).

According to some embodiments of the present application, the UE-A becomes the UE for transmitting sl-BP-RS(s) in response to at least one of the following conditions: (1) the UE-A is configured by a BS to be a UE for transmitting sl-BP-RS(s); or (2) the UE-A determines to become the UE for transmitting sl-BP-RS(s).

In some embodiments, the UE-A is configured by the BS to be the UE for transmitting sl-BP-RS(s) in response to that the BS identifies that UE-A has a capability of being able to transmit sl-BP-RS.

In an embodiment, the capability is represented by bool data. For example, the value “True” of the bool data indicates that the UE-A has a capability of being able to transmit sl-BP-RS and the value “False” of the bool data indicates that the UE-A does not have a capability of being able to transmit sl-BP-RS. The UE-A may report the capability to the BS such that the BS identifies whether the UE-A has a capability of being able to transmit sl-BP-RS. In the case that the BS identifies that the UE-A has a capability of being able to transmit sl-BP-RS, the BS may configure the UE-A to be a UE for transmitting sl-BP-RS(s).

In another embodiment, the capability is indicated by a maximum number of configured sl-BP-RSs (which is referred to as MaxNum-sl-BP-RS). In the case that the MaxNum-sl-BP-RS is larger than 0, it means that the UE-A has a capability of being able to transmit sl-BP-RS. In the case that the MaxNum-sl-BP-RS is equal to 0, it means that the UE-A does not have a capability of being able to transmit sl-BP-RS. The UE-A may report MaxNum-sl-BP-RS to the BS such that the BS identifies whether the UE-A has a capability of being able to transmit sl-BP-RS. In the case that the BS identifies that the UE-A has a capability of being able to transmit sl-BP-RS, the BS may configure the UE-A to be a UE for transmitting sl-BP-RS(s).

In some other embodiments, the UE-A determines to become the UE for transmitting sl-BP-RS(s) in response to at least one of the following:
the UE-A receives an indication from an application layer which indicates the UE-A to become the UE for transmitting sl-BP-RS(s);
a traffic triggered in the UE-A has a priority higher than a priority threshold (e.g., priority-Threshold-sl-BP); or
a timer for determining an occurrence of beam failure expires, for example, the timer is set for UE-A to determine an occurrence of beam failure during a beam-based sidelink communication between UE-A and UE-B.

According to some embodiments of the present application, determining resource(s) for transmitting sl-BP-RS(s) may include determining one or more occasions for S-BPB used for transmitting sl-BP-RS(s) based on a configuration for S-BPB, a number of beams for transmitting the sl-BP-RS(s), a repetition number of each beam for transmitting the sl-BP-RS(s), and an association pattern between occasions for sl-BP-RS and sl-BP-FB used for beam pairing. The configuration for S-BPB may be included in the configuration information for beam paring. In some embodiments, the number of beams for transmitting the sl-BP-RS(s), the repetition number of each beam for transmitting the sl-BP-RS(s), and the association pattern may be also included in the configuration information for beam pairing. In some other embodiments, the number of beams for transmitting the sl-BP-RS(s) and the repetition number of each beam for transmitting the sl-BP-RS(s) may be determined by the UE-A, and the association pattern between occasions for sl-BP-RS and sl-BP-FB used for beam paring may be selected by the UE-A from the association pattern(s) in the configuration information for beam pairing.

In some embodiments of the present application, in step 1001, the UE-A may also determine one or more occasions for receiving sl-BP-FB(s) when it determines the one or more occasions for transmitting sl-BP-RS(s).

For example, in the case that the sl-BP-FB(s) are carried by S-BPB(s), the UE-A may determine one or more occasions for S-BPB used for receiving sl-BP-FB(s) based on the configuration for S-BPB, the number of beams for transmitting the sl-BP-RS(s), the repetition number of each beam for transmitting the sl-BP-RS(s), and the association pattern between occasions for sl-BP-RS and sl-BP-FB used for beam pairing, which can be determined as described above.

Taking FIG. 6 as an example, according to the configuration for S-BPB, N_{Tx}^{Beam}=3, N_{Repetition}^{Beam}=2, and association pattern #1, the UE-A may determine that occasions #0, #1, and #2 are used for transmitting sl-BP-RSs on beam #0, beam #1, and beam #2, respectively and occasions #3, #4, and #5 are used for transmitting sl-BP-RSs on beam #0, beam #1, and beam #2, respectively. The UE-A may also determine that occasions #6, #7, and #8 are used for receiving sl-BP-FBs.

In another example, in the case that the sl-BP-FB(s) are carried by sidelink transmission, the UE-A may determine one or more occasions for receiving sl-BP-FB(s) in a sidelink beam pairing feedback period based on the configuration for sl-BP-FB, the number of beams for transmitting the sl-BP-RS(s), the repetition number of each beam for transmitting the sl-BP-RS(s), and the association pattern between occasions for sl-BP-RS and sl-BP-FB used for beam pairing.

Taking FIG. 9 as an example, according to the configuration for sl-BP-FB, N_{Tx}^{Beam}=3, N_{Repetition}^{Beam}=2, and association pattern #4, the UE-A may determine that occasions #0, #1, and #2 in the sidelink beam pairing period are used for transmitting sl-BP-RSs on beam #0, beam #1, and beam #2, respectively and S-BPB occasions #3, #4, and #5 in the sidelink beam pairing period are used for transmitting sl-BP-RSs on beam #0, beam #1, and beam #2, respectively. The UE-A may also determine that slots #0, #1, and #2 in the sidelink beam paring feedback period are used for receiving sl-BP-FBs.

According to some embodiments of the present application, determining resource(s) for transmitting sl-BP-RS(s) may include determine a primary sequence from a first set of primary sequences and a secondary sequence from a second set of secondary sequences for transmitting the sl-BP-RS(s). The first set of primary sequences and the second set of secondary sequences may be indicated by a configuration for sl-BP-RS, which may be included in the configuration information for beam pairing. For example, it is assumed that the first set of primary sequences includes an m-sequence indexed with 2 and the second set of secondary sequences includes gold sequences with indexes in the set of {0, . . . , 167}, the UE-A may determine that the primary sequence for transmitting the sl-BP-RS(s) is the m-sequence indexed with 2 and the secondary sequence for transmitting the sl-BP-RS(s) is the gold sequence indexed with 3.

After determining the resources for transmitting sl-BP-RS(s), in step 1002, the UE-A may transmit the sl-BP-RS(s) on the determined resources. Each sl-BP-RS transmitted by the UE-A may include at least one of:
a primary sequence determined by UE-A;
a secondary sequence determined by UE-A;
type information indicating sl-BP-RS;
an ID of the UE-A (e.g., a layer-1 ID);
a number of beams for transmitting the sl-BP-RS (e.g., which is “3” in the examples shown in FIGS. 6-9);
a repetition number of each beam for transmitting the sl-BP-RS (e.g., which is “2” in the examples shown in FIGS. 6-9);
an association pattern of the association pattern(s) between occasions for sl-BP-RS and sl-BP-FB in the configuration information (e.g., which is association pattern #1 in the example shown in FIG. 6);
information indicating whether a beam correspondence is enabled on the UE; or
a priority of an intended traffic

In some embodiments of the present application, the UE-A may scramble each sl-BP-RS by an RNTI dedicated for sidelink beam pairing, so as to differentiate the S-BPB carrying the sl-BP-RS from an S-SSB. In an embodiment of the present application, the PSBCH with CRC in S-BPB is scrambled by the RNTI dedicated for sidelink beam pairing.

In step 1002, the UE-B may receive the sl-BP-RS(s) from the UE-A based on the obtained configuration information in response to the UE becoming a UE for transmitting sl-BP-FB(s).

According to some embodiments of the present application, the UE-B becomes a UE for transmitting sl-BP-FB(s) in response to at least one of the following conditions: (1) the UE-B is configured by a BS to be a UE for transmitting sl-BP-FB(s); or (2) the UE-B determines to become the UE for transmitting sl-BP-FB(s).

In some embodiments, the UE-B is configured by the BS to be the UE for transmitting sl-BP-FB(s) in response to that the UE-B supports beam-based sidelink communication (in other words, the UE-B has a capability of performing beam-based sidelink communication) but does not support transmitting sl-BP-RS(s) (in other words, the UE-B does not have a capability of being able to transmit sl-BP-RS).

In an embodiment, the capability is represented by bool data. For example, the value “True” of the bool data indicates that the UE-B has a capability of being able to transmit sl-BP-RS and the value “False” of the bool data indicates that the UE-B does not have a capability of being able to transmit sl-BP-RS. In such embodiments, the UE-B may report “False” to the BS to indicate that the UE-B does not support transmitting sl-BP-RS(s).

In another embodiment, the capability is indicated by a maximum number of configured sl-BP-RSs (which is referred to as MaxNum-sl-BP-RS). In the case that the MaxNum-sl-BP-RS is larger than 0, it means that the UE-B has a capability of being able to transmit sl-BP-RS. In the case that the MaxNum-sl-BP-RS is equal to 0, it means that the UE-B does not have a capability of being able to transmit sl-BP-RS. In such embodiments, the UE-B may report MaxNum-sl-BP-RS equal to 0 to the BS to indicate that the UE-B does not support transmitting sl-BP-RS(s).

In some other embodiments, the UE-B determines to become the UE for transmitting sl-BP-FB(s) in response to at least one of the following:
the UE-B receives an indication from an application layer which indicates the UE-B to become the UE for transmitting sl-BP-FB(s);
a traffic triggered in the UE-B has a priority higher than a priority threshold (e.g., priority-Threshold-sl-BP); or
a timer for determining an occurrence of beam failure expires, for example, the timer is set for UE-B to determine an occurrence of beam failure during a beam-based sidelink communication between UE-B and UE-A.

Specifically, in step 1002, the UE-B may scan across its beams to receive the sl-BP-RS(s). In some embodiments of the present application, the number of beams for receiving sl-BP-RS(s) and transmitting sl-BP-FB(s) may be equal to the repetition number of each beam for transmitting sl-BP-RS(s), and the scanning order across beams may be determined based on the association pattern between occasions for sl-BP-RS and sl-BP-FB used for beam pairing. In some embodiments, the UE-B may determine the number of beams for transmitting the sl-BP-RS(s), the repetition number of each beam for transmitting the sl-BP-RS(s), and the association pattern between occasions for sl-BP-RS and sl-BP-FB used for beam pairing once it receives the first sl-BP-RS from the UE-A. In some other embodiments, the UE-B may directly determine the number of beams for transmitting the sl-BP-RS(s), the repetition number of each beam for transmitting the sl-BP-RS(s), and the association pattern between occasions for sl-BP-RS and sl-BP-FB used for beam pairing from the configuration information for beam paring as described above.

Taking FIG. 6 as an example, since the repetition number of each beam for transmitting sl-BP-RS(s) is 2, the number of beams of the UE-B for receiving sl-BP-RS(s) and transmitting sl-BP-FB(s) is 2, for example, the two beams of the UE-B may be beam #n and beam #n+1. Based on association pattern #1, the UE-B may receive three sl-BP-RSs on occasion #0 to #2 with its beam #n and receive sl-BP-RSs on occasion #3 to #5 with its beam #n+1.

Taking FIG. 7 as an example, since the repetition number of each beam for transmitting sl-BP-RS(s) is 2, the number of beams of the UE-B for receiving sl-BP-RS(s) and transmitting sl-BP-FB(s) is 2, for example, the two beams of the UE-B may be beam #n and beam #n+1. Based on the pattern #2, the UE-B may receive two sl-BP-RSs on occasions #0 and #1 with its beam #n and #n+1, respectively, then receive two sl-BP-RSs on occasions #2 and #3 with its beam #n and #n+1, respectively, and then receive two sl-BP-RSs on occasions #4 and #5 with its beam #n and #n+1, respectively.

After receiving the sl-BP-RS(s), in step 1003, the UE-B may determine one or more sl-BP-RSs within the received sl-BP-RS(s) and beam(s) receiving the one or more sl-BP-RSs. In some embodiments of the present application, the number of sl-BP-RSs determined by UE-B may be equal to the maximum number of sl-BP-RS occasion indicators to be reported as indicated by the association pattern of the received sl-BP-RS(s). The UE-B may determine that the beam(s) receiving the one or more sl-BP-RSs are the paired beam(s) for beam pairing with the UE-A.

In some embodiments of the present application, the UE-B may measure an RSRP for each received sl-BP-RS and determine the one or more sl-BP-RSs based on the measured RSRP for each sl-BP-RS.

In an embodiment, the one or more sl-BP-RSs determined by the UE-B may be sl-BP-RSs associated with measured RSRPs larger than or equal to an RSRP threshold.

In another embodiment, the one or more sl-BP-RSs determined by the UE-B may be sl-BP-RSs associated with measured RSRPs larger than RSRPs associated with the other sl-BP-RSs.

Taking FIG. 6 as an example, it is assumed that in step 1003, the UE-B determines sl-BP-RS on occasion #2 from the six received sl-BP-RSs because the RSRP of sl-BP-RS on occasion #2 measured by the UE-B is largest among the six received sl-BP-RSs. Given this, the UE-B may determine beam #n receiving the sl-BP-RS on occasion #2 to be a paired beam for beam pairing with UE-A.

In step 1004, the UE-B may determine resource(s) for transmitting the sl-BP-FB(s) based on the obtained configuration information (e.g., in the case that the number of beams for transmitting the sl-BP-RS(s), the repetition number of each beam for transmitting the sl-BP-RS(s), and the association pattern between occasions for sl-BP-RS and sl-BP-FB used for beam pairing are included in the configuration information). Alternatively, the UE-B may determine resources for transmitting the sl-BP-FB(s) based on the obtained configuration information and the one or more sl-BP-RSs (e.g., in the case that the number of beams for transmitting the sl-BP-RS(s), the repetition number of each beam for transmitting the sl-BP-RS(s), and the association pattern between occasions for sl-BP-RS and sl-BP-FB used for beam pairing are included in the sl-BP-RS(s)).

In some embodiments of the present application, the sl-BP-FB(s) may be carried by S-BPBs.

In such embodiments, determining resource(s) for transmitting sl-BP-FB(s) may include determining one or more occasions for S-BPB based on the configuration for S-BPB and the one or more sl-BP-RSs. Specifically, the UE-B may determine occasions for S-BPB based on the configuration for S-BPB. Then, the UE-B may determine one or more occasions for S-BPB to be used for transmitting sl-BP-FB(s) based on, for example, the association pattern, the number of beams for transmitting sl-BP-RS(s), and the maximum number of sl-BP-RS occasion indicators to be reported included in the one or more sl-BP-RSs. Taking FIG. 6 as an example, according to the configuration for S-BPB, N_{Tx}^{Beam}=3, N_{Repetition}^{Beam}=2, and association pattern #1, the UE-B may determine that occasions #6, #7, and #8 are used for transmitting sl-BP-FBs.

In such embodiments, determining resource(s) for transmitting sl-BP-FB(s) may also include determine a primary sequence and a secondary sequence for transmitting the sl-BP-FB(s) based on the one or more sl-BP-RSs and an association between sequences for sl-BP-RS and sl-BP-FB. For example, it is assumed that: the primary sequence for sl-BP-RS is the candidate m-sequence indexed with 2 and the secondary sequence for sl-BP-RS is the candidate gold sequence indexed with 3, an association between sequences for sl-BP-RS and sl-BP-FB indicates that a first offset between indexes of primary sequences for sl-BP-RS and sl-BP-FB is 0 and a second offset between indexes of secondary sequences for sl-BP-RS and sl-BP-FB is 168, then the primary sequence for sl-BP-FB is also the candidate m-sequence indexed with 2, and the secondary sequence for sl-BP-FB is the candidate gold sequence indexed with 3+168=171.

In such embodiments, after determining the resource(s) for transmitting the sl-BP-FB(s), in step 1005, the UE-B may transmit the sl-BP-FB(s) on the determined resource(s) on the determined paired beam(s) for beam pairing with the UE-A. Each sl-BP-FB transmitted by the UE-B may include at least one of the following:
a primary sequence determined by the UE-B for transmitting sl-BP-FB;
a secondary sequence determined by the UE-B for transmitting sl-BP-FB;
type information indicating sl-BP-FB;
an ID of the UE-B;
an sl-BP-RS occasion indicator (e.g., indicating an occasion on which one of the determined one or more sl-BP-RSs is transmitted);
information indicating whether a beam associated with the occasion for sl-BP-RS indicated by the sl-BP-RS occasion indicator is a primary beam or a secondary beam;
information indicating an RSRP measured on the beam associated with the occasion for sl-BP-RS indicated by the sl-BP-RS occasion indicator; or
information indicating whether a beam correspondence is enabled on the UE-B.

In some embodiments of the present application, the UE-B may scramble each sl-BP-FB by an RNTI dedicated for sidelink beam pairing, so as to differentiate the S-BPB carrying the sl-BP-FB from an S-SSB. In an embodiment of the present application, the PSBCH with CRC in S-BPB is scrambled by the RNTI dedicated for sidelink beam pairing.

Taking FIG. 6 as an example, it is assumed that in step 1003, the sl-BP-RS determined by the UE-B is sl-BP-RS on occasion #2 and thus the beam receiving the sl-BP-RS is beam #n. Then, in step 1005, the UE-B may transmit three sl-BP-FBs on occasions #6, #7, and #8 on beam #n. Each sl-BP-FB may include an sl-BP-RS occasion indicator indicating occasion #2.

In step 1005, the UE-A may attempt to receive sl-BP-FB(s) on the occasion(s) for receiving sl-BP-FB(s) determined in step 1001. Taking FIG. 6 as an example, the UE-A may attempt to receive sl-BP-FB(s) on occasions #6, #7, and #8.

After receiving the sl-BP-FB(s), in step 1006, the UE-A may identify beam(s) of the UE-A based on the received sl-BP-FB(s). The identified beam(s) may be the paired beam(s) for beam pairing with UE-B.

In some embodiments, the UE-A may identify beam(s) based on an sl-BP-RS occasion indicator in each sl-BP-FB. Still taking FIG. 6 as an example, the UE-A may receive three sl-BP-FBs, and each sl-BP-FB may include an sl-BP-RS occasion indicator indicating occasion #2. Based on the association pattern between occasions for sl-BP-RS and sl-BP-FB, the UE-A may determine that occasion #2 is used for transmitting sl-BP-RS on beam #2. Then, the UE-A may identify that the beam #2 is a paired beam for beam pairing with the UE-B.

In some other embodiments, the UE-A may identify beams based on the association pattern between occasions for sl-BP-RS and sl-BP-FB and the sl-BP-FB(s). In such embodiments, the sl-BP-FB(s) may not include an sl-BP-RS occasion indicator. Taking FIG. 8 as an example, the UE-A may determine occasions #2, #5, and #8 are used for receiving sl-BP-FB(s). In such cases, if the UE-A receives sl-BP-FB on occasions #2, the UE-A may determine that beam #0 is a paired beam for beam pairing with UE-B based on the association pattern between occasions for sl-BP-RS and sl-BP-FB.

In some other embodiments of the present application, an sl-BP-FB may be carried by a sidelink transmission. A sidelink transmission may include at least one of PSCCH or PSSCH. In such embodiments, in step 1004, determining resource(s) for transmitting sl-BP-FB(s) may include determining one or more occasions in the sidelink beam pairing feedback period based on the configuration for sl-BP-FB and the one or more sl-BP-RSs. Specifically, referring to FIG. 9, based on the sl-BP-FB period, the sl-BP-RS-FB-Offset, and the frequency position included in the configuration for sl-BP-FB, the UE-B may determine a sidelink beam pairing feedback period for transmitting sl-BP-FB(s). In addition, based on the number of beams for transmitting sl-BP-RS and the maximum number of sl-BP-RS occasion indicators to be reported, the UE-B may determine the number of occasions in the sidelink beam pairing feedback period used for transmitting the sl-BP-FB(s) (e.g., which is 3 in the example shown in FIG. 9). In such embodiments, each occasion for transmitting an sl-BP-FB is one slot. The occasions for transmitting sl-BP-FB(s) are logically continuous and the start point of the occasions for transmitting sl-BP-FB(s) is the same as the start point of the sidelink beam pairing feedback period.

In such embodiments, after determining the resource(s) for transmitting the sl-BP-FB(s), in step 1005, the UE-B may transmit the sl-BP-FB(s) on the determined resource(s) on the determined paired beams for beam pairing with the UE-A. Each sl-BP-FB transmitted by the UE-B may include at least one of the following:
type information indicating sl-BP-FB;
an ID of the UE-B;
an ID of the UE-A;
an sl-BP-RS occasion indicator (e.g., indicating an occasion on which one of the determined one or more sl-BP-RSs is transmitted);
information indicating whether a beam associated with the occasion for sl-BP-RS indicated by the sl-BP-RS occasion indicator is a primary beam or a secondary beam;
information indicating an RSRP measured on the beam associated with the occasion for sl-BP-RS indicated by the sl-BP-RS occasion indicator; or
information indicating whether a beam correspondence is enabled on the UE-B.

In some embodiments of the present application, the first three items of the above may be included in SCI (e.g., 1^{st}-stage SCI or 2^{nd}-stage SCI) of a sidelink transmission, and the remaining items may be included in a PSSCH of the sidelink transmission. For example, the remaining items may be transmitted to the UE-A via a medium access control (MAC) control element (CE).

In step 1005, the UE-A may attempt to receive sl-BP-FB(s) on the occasion(s) for receiving sl-BP-FB(s) determined in step 1001. Taking FIG. 9 as an example, the UE-A may attempt to receive sl-BP-FB(s) on occasions #1, #2, and #3 in the sidelink beam pairing feedback period.

After receiving the sl-BP-FB(s), in step 1006, the UE-A may identify beam(s) of the UE-A based on the received sl-BP-FB(s). The identified beam(s) may be the paired beam(s) for beam pairing with UE-B.

In some embodiments, the UE-A may identify beam(s) based on an sl-BP-RS occasion indicator in each sl-BP-FB. Taking FIG. 9 as an example, the UE-A may receive three sl-BP-FBs, and each sl-BP-FB may include an sl-BP-RS occasion indicator indicating occasion #2 for sl-BP-RS. Based on the association pattern between occasions for sl-BP-RS and sl-BP-FB, the UE-A may determine that occasion #2 is used for transmitting sl-BP-RS on beam #2. Then, the UE-A may identify that beam #2 is a paired beam for beam pairing with the UE-B.

FIG. 11 illustrates a simplified block diagram of an exemplary apparatus 1100 for resource selection according to some embodiments of the present application. In some embodiments, the apparatus 1100 may be or include at least part of a UE (e.g., UE 101a or UE 101b in FIG. 1). In some other embodiments, the apparatus 1100 may be or include at least part of a BS (e.g., BS 102 in FIG. 1).

Referring to FIG. 11, the apparatus 1100 may include at least one transmitter 1102, at least one receiver 1104, and at least one processor 1106. The at least one transmitter 1102 is coupled to the at least one processor 1106, and the at least one receiver 1104 is coupled to the at least one processor 1106.

Although in this figure, elements such as the transmitter 1102, the receiver 1104, and the processor 1106 are illustrated in the singular, the plural is contemplated unless a limitation to the singular is explicitly stated. In some embodiments of the present application, the transmitter 1102 and the receiver 1104 may be combined to one device, such as a transceiver. In some embodiments of the present application, the apparatus 1100 may further include an input device, a memory, and/or other components. The transmitter 1102, the receiver 1104, and the processor 1106 may be configured to perform any of the methods described herein (e.g., the method described with respect to FIG. 10).

According to some embodiments of the present application, the apparatus 1100 may be a UE transmitting sl-BP-RS(s) and receiving sl-BP-FB(s) (e.g., UE-A in FIG. 10), and the transmitter 1102, the receiver 1104, and the processor 1106 may be configured to perform operations of the method as described with respect to FIG. 10. For example, the processor 1106 may be configured to: obtain configuration information for beam pairing based on configuration or pre-configuration, wherein the configuration information includes at least one of: a configuration for S-BPB; a configuration for sl-BP-RS; a configuration for sl-BP-FB; or association pattern(s) between occasions for sl-BP-RS and sl-BP-FB; and determine resource(s) for transmitting sl-BP-RS(s) based on the obtained configuration information in response to the UE becoming a UE for transmitting sl-BP-RS(s). The transmitter 1102 may be configured to: transmit the sl-BP-RS(s) on the determined resource(s). The receiver 1104 may be configured to receive sl-BP-FB(s) based on the obtained configuration information and the sl-BP-RS(s). In some embodiments, the processor 1106 may be further configured to identify beam(s) of the UE based on the sl-BP-FB(s).

According to some embodiments of the present application, the apparatus 1100 may be a UE transmitting sl-BP-FB(s) and receiving sl-BP-RS(s) (e.g., UE-B in FIG. 10), and the transmitter 1102, the receiver 1104, and the processor 1106 may be configured to perform operations of the method as described with respect to FIG. 10. For example, the processor may be configured to obtain configuration information for beam pairing based on configuration or pre-configuration, wherein the configuration information includes at least one of: a configuration for S-BPB; a configuration for sl-BP-RS; a configuration for sl-BP-FB; or association pattern(s) between occasions for sl-BP-RS and sl-BP-FB. The receiver 1104 may be configured to: receive sl-BP-RS(s) based on the obtained configuration information in response to the UE becoming a UE for transmitting sl-BP-FB(s). In some embodiments, the processor 1106 may be further configured to: determine one or more sl-BP-RSs within the received sl-BP-RS(s) and beam(s) receiving the one or more sl-BP-RSs; and determine resource(s) for transmitting the sl-BP-FB(s) based on the obtained configuration information and the one or more sl-BP-RSs. The transmitter 1102 may be configured to transmit the sl-BP-FB(s) on the determined resource(s).

According to some embodiments of the present application, the apparatus 1100 may be a BS. The transmitter 1102 may be configured to transmit configuration information for beam pairing, wherein the configuration information includes at least one of: a configuration for S-BPB; a configuration for sl-BP-RS; a configuration for sl-BP-FB; or association pattern(s) between occasions for sl-BP-RS and sl-BP-FB.

In some embodiments of the present application, the apparatus 1100 may further include at least one non-transitory computer-readable medium. In some embodiments of the present disclosure, the non-transitory computer-readable medium may have stored thereon computer-executable instructions to cause the processor 1106 to implement any of the methods as described above. For example, the computer-executable instructions, when executed, may cause the processor 1106 to interact with the transmitter 1102 and/or the receiver 1104, so as to perform operations of the methods, e.g., as described with respect to FIG. 10.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for sidelink beam management, including a processor and a memory. Computer programmable instructions for implementing a method for sidelink beam management are stored in the memory, and the processor is configured to perform the computer programmable instructions to implement the method for sidelink beam management. The method for sidelink beam management may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for sidelink beam management according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

What is claimed is:

1-15. (canceled)

16. A user equipment (UE) for wireless communication, comprising:
at least one memory; and
at least one processor coupled with the at least one memory and configured to cause the UE to:
obtain configuration information for beam pairing based on configuration or pre-configuration, wherein the configuration information includes at least one of:
a configuration for sidelink beam pairing block (S-BPB);
a configuration for sidelink beam pairing reference signal (sl-BP-RS);
a configuration for sidelink beam pairing feedback (sl-BP-FB); or
one or more association patterns between occasions for sl-BP-RS and sl-BP-FB;
determine one or more resources for transmitting sl-BP-RS based on the obtained configuration information and in response to the UE becoming a UE for transmitting sl-BP-RS;
transmit the sl-BP-RS on the determined one or more resources;
receive sl-BP-FB based on the obtained configuration information and the sl-BP-RS; and
identify one or more beams of the UE based on the sl-BP-FB.

17. The UE of claim 16, wherein the UE becomes a UE for transmitting sl-BP-RS in response to at least one of:
the UE is configured by a base station to be the UE for transmitting sl-BP-RS; or
the UE determines to become the UE for transmitting sl-BP-RS.

18. The UE of claim 16, wherein the configuration for S-BPB indicates at least one of:
a duration of a sidelink beam pairing period for S-BPB;
a sidelink beam pairing offset for S-BPB;
a sidelink beam pairing interval for S-BPB; or
a number of S-BPBs per sidelink beam pairing period.

19. The UE of claim 18, wherein to determine one or more resources for transmitting the sl-BP-RS, the at least one processor is configured to cause the UE to determine one or more occasions for S-BPB based on the configuration for S-BPB and an association pattern between occasions for sl-BP-RS and sl-BP-FB included in the configuration information.

20. The UE of claim 16, wherein the configuration for sl-BP-RS includes a first set of primary sequences and a second set of secondary sequences for sl-BP-RS and indicates that an sl-BP-RS includes at least one of:
type information indicating sl-BP-RS or sl-BP-FB;
an identification (ID) of a UE transmitting the sl-BP-RS;
a number of beams for transmitting the sl-BP-RS;
a repetition number of each beam for transmitting the sl-BP-RS;
an association pattern within the one or more association patterns between occasions for sl-BP-RS and sl-BP-FB in the configuration information;
information indicating whether a beam correspondence is enabled on the UE transmitting the sl-BP-RS; or
a priority of an intended traffic.

21. The UE of claim 20, wherein to determine one or more resources for transmitting sl-BP-RS, the at least one processor is configured to cause the UE to determine a primary sequence from the first set of primary sequences and a secondary sequence from the second set of secondary sequences for transmitting the sl-BP-RS.

22. The UE of claim 16, wherein the configuration for sl-BP-FB includes an association between sequences for sl-BP-RS and sl-BP-FB and indicates that an sl-BP-FB includes at least one of:
type information indicating sl-BP-RS or sl-BP-FB;
an identification (ID) of a UE transmitting the sl-BP-FB;
an sl-BP-RS occasion indicator;
information indicating whether a beam associated with an occasion for sl-BP-RS indicated by the sl-BP-RS occasion indicator is a primary beam or a secondary beam;
information indicating a reference signal received power (RSRP) measured on the beam associated with the occasion for sl-BP-RS indicated by the sl-BP-RS occasion indicator; or
information indicating whether a beam correspondence is enabled on the UE transmitting the sl-BP-FB.

23. The UE of claim 16, wherein the configuration for sl-BP-FB indicates at least one of:
a duration of a sidelink beam pairing feedback period in a resource pool for sidelink transmission;
an offset of a starting point of a sidelink beam pairing feedback period relative to a reference point, wherein the reference point is one of a first slot of the pool, a starting point of a sidelink beam pairing period, or an end point of a sidelink beam pairing period; or
a frequency position for sl-BP-FB in the resource pool.

24. The UE of claim 16, wherein each association pattern between occasions for sl-BP-RS and sl-BP-FB includes at least one of:
an association pattern index;
a repetition flag indicating a repetition order of sl-BP-RS on beams;
an order flag indicating an order of transmissions of sl-BP-RS and sl-BP-FB;
a maximum number of sl-BP-RS occasion indicators to be reported by a UE for transmitting sl-BP-FB; or
a stop flag indicating a stop condition of transmissions of sl-BP-RS and sl-BP-FB.

25. The UE of claim 16, wherein an sl-BP-RS of the sl-BP-RS is carried by an S-BPB and includes at least one of:
a primary sequence;
a secondary sequence;
type information indicating sl-BP-RS;
an identification (ID) of the UE;
a number of beams for transmitting the sl-BP-RS;
a repetition number of each beam for transmitting the sl-BP-RS;
an association pattern of the one or more association patterns between 22 occasions for sl-BP-RS and sl-BP-FB in the configuration information;
information indicating whether a beam correspondence is enabled on the UE; or
a priority of an intended traffic.

26. The UE of claim 16, wherein an sl-BP-FB of the sl-BP-FB is carried by an S-BPB and includes at least one of:
a primary sequence;
a secondary sequence;
type information indicating sl-BP-FB;
an ID of a UE transmitting the sl-BP-FB;
an sl-BP-RS occasion indicator;
information indicating whether a beam associated with an occasion for sl-BP-RS indicated by the sl-BP-RS occasion indicator is a primary beam or a secondary beam;
information indicating a reference signal received power (RSRP) measured on the beam associated with the occasion for sl-BP-RS indicated by the sl-BP-RS occasion indicator; or
information indicating whether a beam correspondence is enabled on the UE transmitting the sl-BP-FB.

27. The UE of claim 16, wherein an sl-BP-FB of the sl-BP-FB is carried by a sidelink transmission and includes at least one of:
type information indicating sl-BP-FB;
an identification (ID) of a UE transmitting the sl-BP-FB;
an ID of the UE transmitting the sl-BP-RS;
an sl-BP-RS occasion indicator;
information indicating whether a beam associated with an occasion for sl-BP-RS indicated by the sl-BP-RS occasion indicator is a primary beam or a secondary beam;
information indicating a reference signal received power (RSRP) measured on the beam associated with the occasion for sl-BP-RS indicated by the sl-BP-RS occasion indicator; or
information indicating whether a beam correspondence is enabled on the UE transmitting the sl-BP-FB.

28. The UE of claim 16, wherein the at least one processor is configured to cause the UE to scramble each sl-BP-RS by a radio network temporary identifier (RNTI) dedicated for sidelink beam pairing.

29. A user equipment (UE) for wireless communication, comprising:
at least one memory; and
at least one processor coupled with the at least one memory and configured to cause the UE to:
obtain configuration information for beam pairing based on configuration or pre-configuration, wherein the configuration information includes at least one of:
a configuration for sidelink beam pairing block (S-BPB);
a configuration for sidelink beam pairing reference signal (sl-BP-RS);
a configuration for sidelink beam pairing feedback (sl-BP-FB); or
association pattern(s) between occasions for sl-BP-RS and sl-BP-FB;
receive sl-BP-RS based on the obtained configuration information in response to the UE becoming a UE for transmitting sl-BP-FB;
determine one or more sl-BP-RSs within the received sl-BP-RS and one or more beams receiving the one or more sl-BP-RSs;
determine one or more resources for transmitting the sl-BP-FB based on the obtained configuration information and the one or more sl-BP-RS; and
transmit the sl-BP-FB on the determined resource.

30. A base station for wireless communication, comprising, comprising:
at least one memory; and
at least one processor coupled with the at least one memory and configured to cause the base station to:
transmit configuration information for beam pairing, wherein the configuration information includes at least one of:
a configuration for sidelink beam pairing block (S-BPB); BP-RS);
a configuration for sidelink beam pairing feedback (sl-BP-FB); or
one or more association patterns between occasions for sl-BP-RS and sl-BP-FB.

31. A processor for wireless communication, comprising:
at least one controller coupled with at least one memory and configured to cause the processor to:
obtain configuration information for beam pairing based on configuration or pre-configuration, wherein the configuration information includes at least one of:
a configuration for sidelink beam pairing block (S-BPB);
a configuration for sidelink beam pairing reference signal (sl-BP-RS);
a configuration for sidelink beam pairing feedback (sl-BP-FB); or
one or more association patterns between occasions for sl-BP-RS and sl-BP-FB;
determine one or more resources for transmitting sl-BP-RS based on the obtained configuration information and in response to a user equipment (UE) becoming a UE for transmitting sl-BP-RS;
transmit the sl-BP-RS on the determined one or more resources;
receive sl-BP-FB based on the obtained configuration information and the sl-BP-RS; and
identify one or more beams of the UE based on the sl-BP-FB.

32. The processor of claim 31, wherein a user equipment (UE) associated with the processor becomes a UE for transmitting sl-BP-RS in response to at least one of:
the UE is configured by a base station to be the UE for transmitting sl-BP-RS; or
the UE determines to become the UE for transmitting sl-BP-RS.

33. The processor of claim 31, wherein the configuration for S-BPB indicates at least one of:
a duration of a sidelink beam pairing period for S-BPB;
a sidelink beam pairing offset for S-BPB;
a sidelink beam pairing interval for S-BPB; or
a number of S-BPBs per sidelink beam pairing period.

34. The processor of claim 33, wherein to determine one or more resources for transmitting the sl-BP-RS, the at least one controller is configured to cause the processor to determine one or more occasions for S-BPB based on the configuration for S-BPB and an association pattern between occasions for sl-BP-RS and sl-BP-FB included in the configuration information.

35. The processor of claim 31, wherein the configuration for sl-BP-RS includes a first set of primary sequences and a second set of secondary sequences for sl-BP-RS and indicates that an sl-BP-RS includes at least one of:
type information indicating sl-BP-RS or sl-BP-FB;
an identification (ID) of a user equipment (UE) transmitting the sl-BP-RS;
a number of beams for transmitting the sl-BP-RS;
a repetition number of each beam for transmitting the sl-BP-RS;
an association pattern within the one or more association patterns between occasions for sl-BP-RS and sl-BP-FB in the configuration information;
information indicating whether a beam correspondence is enabled on the UE transmitting the sl-BP-RS; or
a priority of an intended traffic.
